(19) United States
(12) Patent Application Publication
(10) Pub. No.: US 2011/0161824 A1
(43) Pub. Date: Jun. 30, 2011

(54) Process and system for interaction with an application that is shared among multiple users

(75) Inventors: Francois COLDEFY, Lannion (FR); Mohammed BELATAR, Safi (MA)

(73) Assignee: FRANCE TELECOM, Paris (FR)

(21) Appl. No.: 12/963,842

(22) Filed: Dec. 9, 2010

(30) Foreign Application Priority Data
Dec. 10, 2009 (FR) 0958856

(51) Int. Cl. G06F 3/048

(52) U.S. Cl. 715/735

(57) ABSTRACT

This invention relates in a general way to the shared digital interfaces that allow collaborative work among multiple users, and in particular a process and a system for interaction with a common application (12) that is shared among multiple users (A, B, C).

The shared application has at least one function and is displayed in a common application component (22) of a physical interface (10) that is shared among the users.

The process according to the invention comprises the stages that consist in:
Creating an individualized component (24, 24′), independent from said common application component (22), with which a user can interact individually to define, by means of the shared physical interface, at least one parameter of said function;
For said user, interacting with the shared application by linking said individualized component to the common application component so as to define said function.

This invention relates in a general way to the shared digital interfaces that allow collaborative work among multiple users, and in particular a process and a system for interaction with a shared common application.

Collaborative work relates to the digital activities that are conducted simultaneously by multiple users, such as, for example, the search for information on the web (finding an apartment or a vacation, gifts for children, etc.) or the consultation of databases (tracking of stocks, deliveries for professionals).

It has been observed that traditional collective activities involve an alternation between collective phases during which people interact on the activity in progress and individual phases during which each conducts an independent activity in relation to the collective task.

The collaborative work can be implemented on digital interfaces that allow the simultaneous interaction of multiple users, such as tables, tablets or interactive screens, TabletPC-type touch screens, white boards, interactive walls, or else multi-touch digital boards.

To illustrate the invention, the focus below is on the search for digital information on the web. However, one skilled in the art is able to apply the invention to other applications, for example the consultation of databases, the display of digital data (tomographic or seismological images, technical drawings produced by the users, texts written by the latter, etc.).

Thus, to operate a web consultation, the user traditionally uses a search engine that is accessible by a web page: Google, Bing, Yahoo (commercial names), etc. This web page is conventionally displayed in an application component, for example a browser window on the screen of its computer.

The user then inputs a request to the keyboard on the web page or in a dedicated zone of the browser, such as, for example, in the toolbar (Google Toolbar). It then launches the search function, triggering the execution of the request. The result is next displayed below, in the updated page.

Each hypertext link (or hyperlink) that is combined with each element of the result in its turn can be clicked so as to explore the digital result data.

Certain web applications can also implement additional windows that are temporarily displayed to input, for example, a password. The web application and this window are closely linked, however, in that the latter is used only with the corresponding web application.

The shared use of a browser is, however, generally difficult, in particular because the computers are initially provided for individual use.

A disparity of the roles of the different users and discomfort for some of them result from the latter. Actually, a single “master” user controls the physical interface (keyboard, mouse and screen) of the digital interaction device. Only this user interacts with the digital data, and the others are restricted to being spectators or to discussing and prompting the “master” user to undertake such and such an interaction or even to step aside.

This is illustrated in the case of a shared web browser whose common application component for the display and interaction is placed at the center of an interactive table.

Before launching any new search using the shared web browser, a user has to negotiate an agreement with the others in order to take control of the page or the application so as to bring it toward him for inputting the text of his new request.

The user, by appropriating the common application component that displays the shared application, interrupts the activity of the others on the latter, who have to wait for the end of the interaction sequence: orientation to oneself of the component using tools for rotation/movement/resizing, inputting text, launching of the request, and then restoration of the page in the center of the interactive table to allow the common display of the results.

During this interaction sequence, the other users no longer have access or have poor access to the shared browser, even for a simple display.

Furthermore, when two users wish to input different requests at the same time on the shared browser, they have to negotiate the one that will ultimately take control of the browser. This produces possible ineffective delays, in particular when at the end, the second user in turn is brought in to input his request following fruitless results of the first user in particular.

There is therefore a need to improve the collective interaction from the same physical interface, i.e., to improve the negotiated interactions of users on the same common application component that focuses the attention of the group of users (a web browser in our example).

Several collaborative technical solutions that are proposed in particular by the publications “WebSurface: An Interface for Co-Located Collaborative Information Gathering” by Philip Tuddenham, Ian Davies and Peter Robinson (WebSurface below) and “CoSearch: A System for Co-Located Collaborative Web Search” by Saleema Amershi and Meredith Ringel Morris, CHI 2008 (CoSearch below) are known, however.

The WebSurface solution implements conventional web browsers and a physical interface, here an interactive table, using a keyboard and a stylus that belong to each user. The collaborative work of this solution rests primarily on the capacities of the system to be able to drag an application window from one user to the next on the interactive table.

The difficulties disclosed above are still present, however, in this solution, because the browsers that are used are conventional, i.e., provided for an individual user.

In CoSearch, a web browser suitable for browsing by multiple users is proposed. This browsing can be implemented in particular via a multi-mouse interaction on the same computer (CoSearchPC) that is connected to a single keyboard or via portable terminals that belong to each user (CoSearchMobile).

This solution rests on the use of tabs and color codes for recording and identifying requests from all of the users on the shared browser window and thus for allowing, upon demand, access to one of these requests within the common application component (the web browser).

There again, despite the use of several concurrent mice on the computer, all of the interactions of the users are concentrated at the single shared web browser. The individual phases that are necessary for an effective implementation of a collective work are therefore very limited and difficult to implement.

Finally, a collaborative search system using an interactive table where each user has personal tokens to define search criteria is known from the publication “TeamSearch: Comparing Techniques for Co-Present Collaborative Search of Digital Media” (M. R. Morris et al., 2006).

However, these tokens are pasted by the users onto common widget components to form either individual requests or collective requests. The use of these common components during individual phases can, however, create a problem between users, and can even influence some of them based on the tokens that will have been able to be pasted on by the other users.

In relation to the drawbacks of the techniques of the art, a perceived need is that of improving the fluidity of the group interactions on a single physical interface, in particular by making simple the collective interactions and the individual interactions that are necessary to an effective collective work and by allowing their coexistence.

In this drawing, the invention relates in particular to a process for interaction with an application that is shared among multiple users, whereby the shared application has at least one function and is displayed in a common application component of a physical interface that is shared among the users, characterized in that it comprises the stages that consist in:

Creating an individualized component, independent from said common application component, with which a user can interact individually;

Using the shared physical interface, defining, by the user, at least one parameter of said function inside the individualized component that is created;

For said user, interacting with the shared application by linking said individualized component that comprises at least one defined parameter to the common application component so as to define said function.

“Independent” is defined as the fact that the individualized component is not, by definition, linked to the common application component and therefore can be exploited independently of the common application component. In other words and as will be seen below, it is configured to be able to be used equally with one or the other among multiple separate application components (which are separate applications or separate instances of the same applications).

The concept of “individualized” relates to the fact that the purpose of the corresponding component is to be used only by the user. It therefore corresponds to a personal activity that, owing to the subsequent link with the common application component, relates to the collective task.

The stages of the invention correspond, in an example described below in more detail, in particular in creating an independent “request” component inside of which the user independently inputs web search criteria, and then in controlling a web browser that is shared using any one of the “request” components of multiple users to carry out a search that corresponds to the criteria of the component that is adopted.

As it emerges from the general definition of the invention and from this example, the invention, owing to the use of independent individualized components inside of which each user can define his own search strategies, makes it possible to combine the individual interventions for the use of these individualized components and the intervention with the common purpose by interaction between the individualized component and the shared application.

Because a portion of the collaborative works is thus implemented individually in the individualized component, the time of taking control of the shared application by one of the users is reduced to the action of linking the two components. The result is less convenience to the other users, for example during the input of a request, whereas in the known techniques, this input on the physical interface monopolizes the shared application or involves components that are common to the set of users.

Furthermore, the use of an independent component offers high freedom of exploitation of its work through this component: either the negotiations end in the sharing of this work and the interaction with the common application component is implemented, or the negotiations do not end, and this independent component can be used individually with other individually called applications in particular.

Finally, this invention makes it possible to effectively reconcile, at any time, the collective interaction and the individual interaction by linking or not linking the interaction between the two common and individualized components.

In particular, the interaction action with the shared application comprises a drag-and-drop action of said individualized component on said common application component. In this way, the intervention of the user for providing his contribution is reduced to a minimum.

In particular—the shared application implementing a search function in at least one source of digital data, for example the Internet or a database—the drag-and-drop action on the common application component triggers the execution of a request that comprises a search criterion, said at least one parameter. This arrangement perfectly illustrates an advantage of this invention, since each user can have his own individualized component to specify there the search criteria, and then after negotiation, the selected user submits his own search criteria to the shared application.

Thus, according to one characteristic of the invention, it is possible to provide for:

Creating, by at least one other user, an individualized component, independent from the common application component, with which this other user can interact individually;

Using the shared physical interface, defining, by this other user, at least one parameter of said function inside of the individualized component that is created by this other user;

Selecting a user from among the set of users for interacting with the shared application by linking the individualized component of the user that is selected to the common application component.

The users that are not adopted can individually exploit their requests at the level of another optionally personal application. To do this, the individualized components are configured to be linked just as well to the common component that corresponds to said shared application or to another component that corresponds to another application, and

a user that is not selected interacts with said other application by linking his individualized component to said other component that corresponds to this other application.

In one embodiment, the creation of the individualized component comprises the trace, by the user, on the shared physical interface, of a graphic shape so as to create, at the location of the trace, an individualized component that comprises a field of definition of at least one parameter of the function. This arrangement makes it possible to create individually the interaction components that are independent and that can be used with the shaped application without disturbing the other users. This creation by trace is furthermore efficient in that it makes it possible, by the same action, to organize the personal work space of the user effectively.

Different techniques for defining the function of the component that is created can be considered: trace of a graphic shortcut (for example, the form of a question mark) launching a component for inputting key search terms, trace of a form that defines the form and the dimensions of the individualized component, and then assignment of the function of the created component either by menu or by contextual menu (optionally reduced to a single possibility), etc.

Accordingly, the invention relates to a system for interaction with an application that is shared among multiple users and that has at least one function, whereby the system comprises:

A physical interface that is shared among the users, adapted to display said shared application in a common application component;

Means for creating, using the shared physical interface, an individualized component that is independent of said common application component, with which a user can interact individually, whereby said created, individualized component comprises a field for defining there at least one parameter of said function;

Means for processing an interaction signal from said user with the shared application, by linking said individualized component that comprises at least one parameter that is defined to the common application component so as to define said function.

The interaction system offers advantages that are similar to those of the interaction process that is disclosed above, in particular the one of improving the interaction during a collective work session, by making it possible to easily produce collective actions on the common component and individual actions (on the independent component) in relation with the collective work (connection during the interaction between the individual work and the common component that is dedicated to the collective work).

Optionally, the system can comprise means that relate to the characteristics of the process disclosed above.

In particular, the system comprises a second application that implements at least one function and comprises a number of individualized components, each equipped with a field to define there said at least one parameter, said individualized components being configured to be equally linked to a component that corresponds to one or the other of the two applications that implement at least one function.

The invention also relates to a data storage means comprising instructions for a computer program that is suitable for implementing the interaction process according to the invention when this program is loaded and executed by a computer system.

The invention also relates to a computer program that can be read by a microprocessor, comprising instructions for the implementation of the interaction process according to the invention, when this program is loaded and executed by the microprocessor.

The data storage means and the computer program have characteristics and advantages that are analogous to the processes that they implement.

Other particular features and advantages of the invention will emerge in the description below, illustrated by the accompanying drawings, in which:

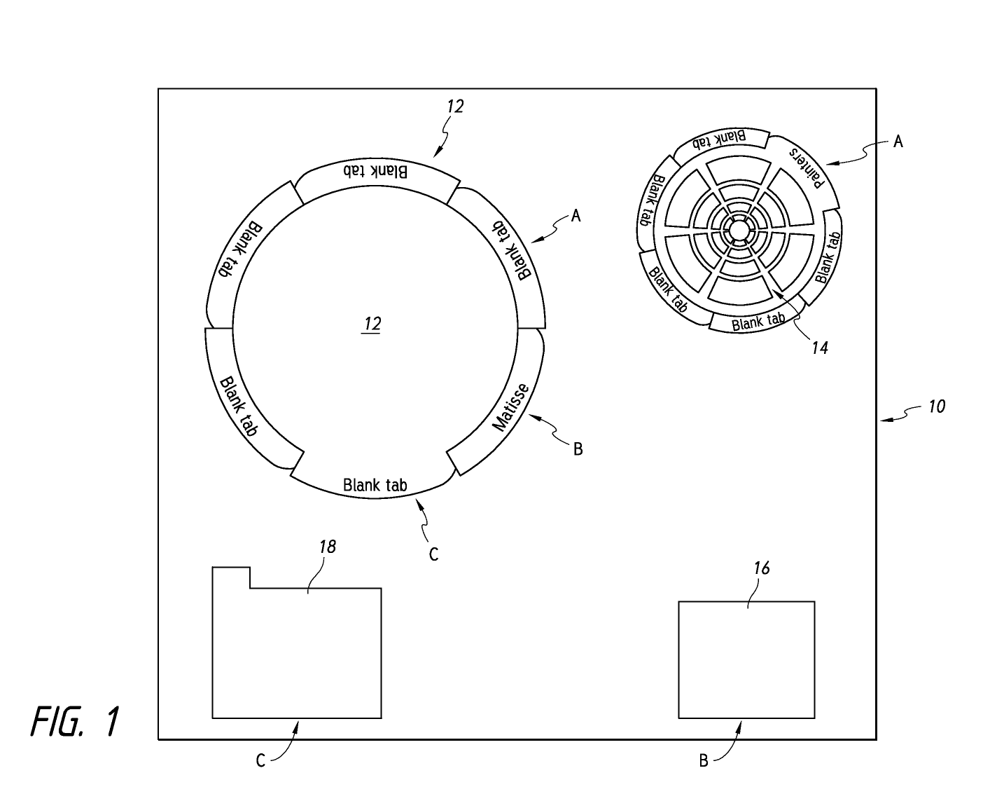

FIG. 1 represents a shared graphic interface that displays a shared web browser;

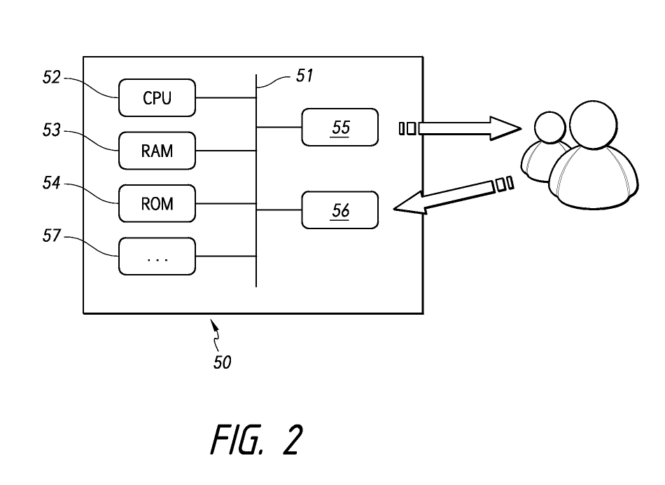

FIG. 2 shows a particular material configuration of a device that is capable of an implementation of the process according to the invention;

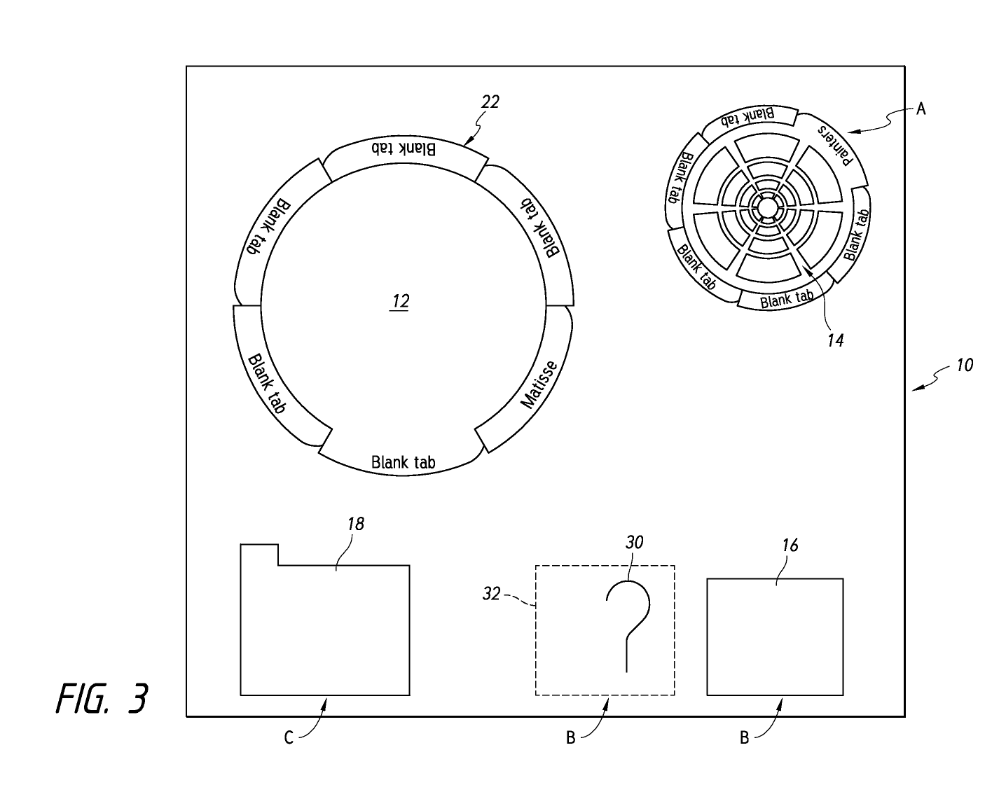

FIG. 3 represents the trace of a component for inputting a request by a user on the interface of FIG. 1;

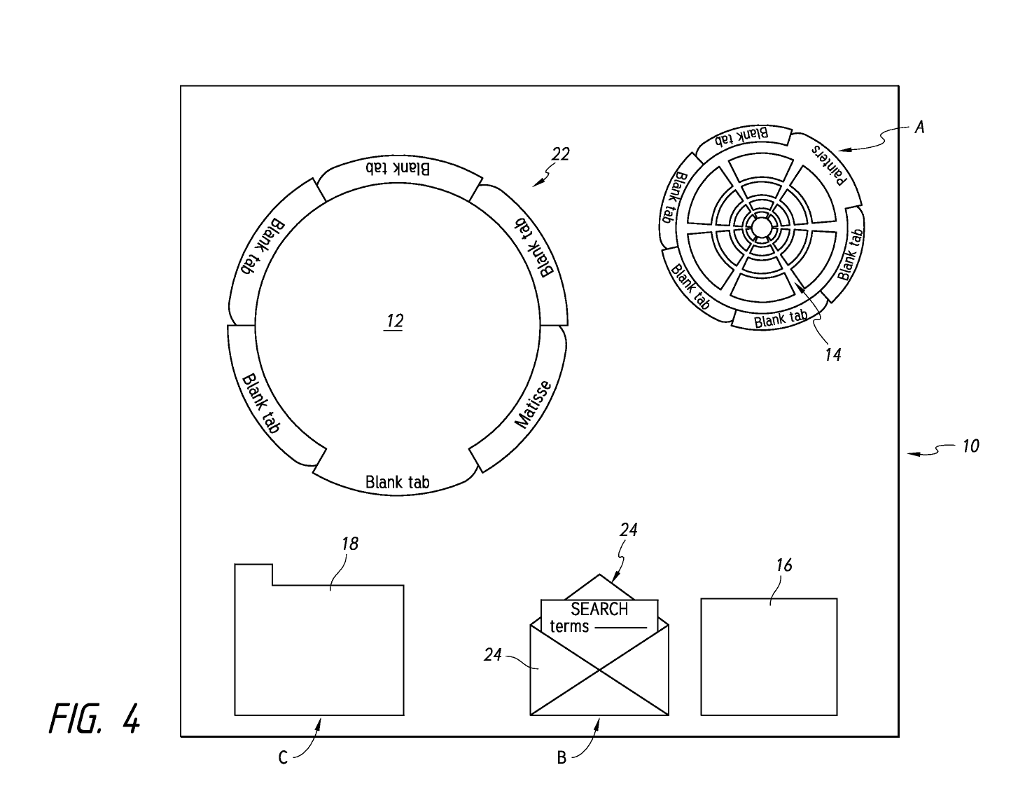

FIG. 4 illustrates the display of the component for inputting the request traced in FIG. 3;

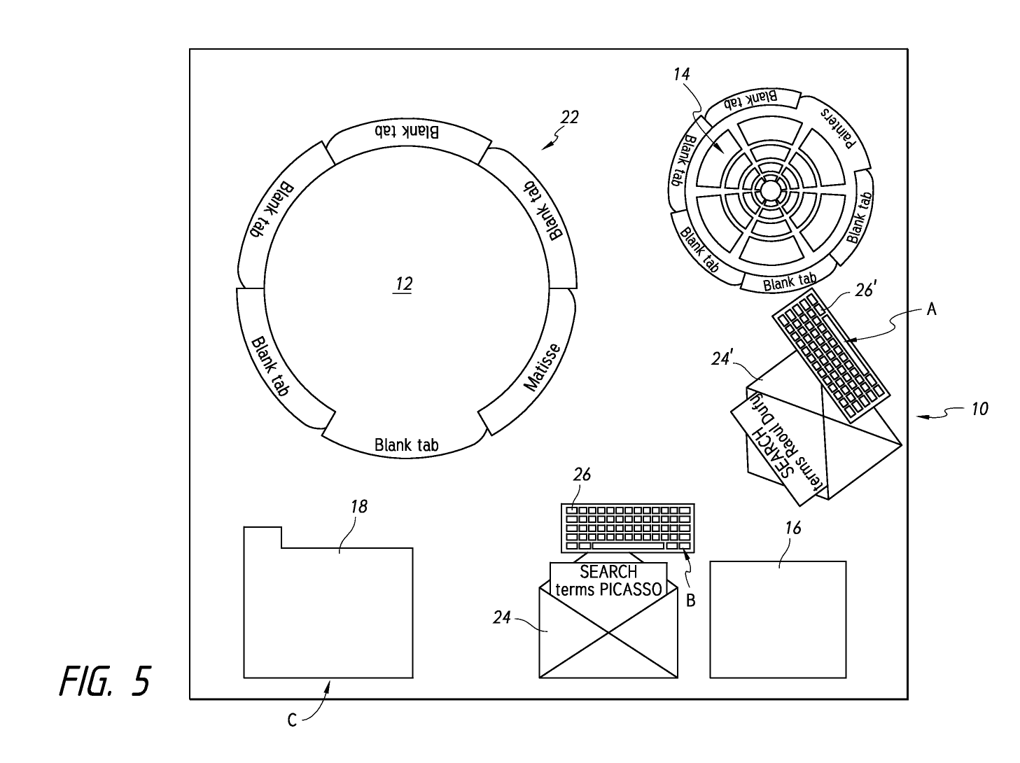

FIG. 5 illustrates the inputting of key words in the component for inputting the request of FIG. 4;

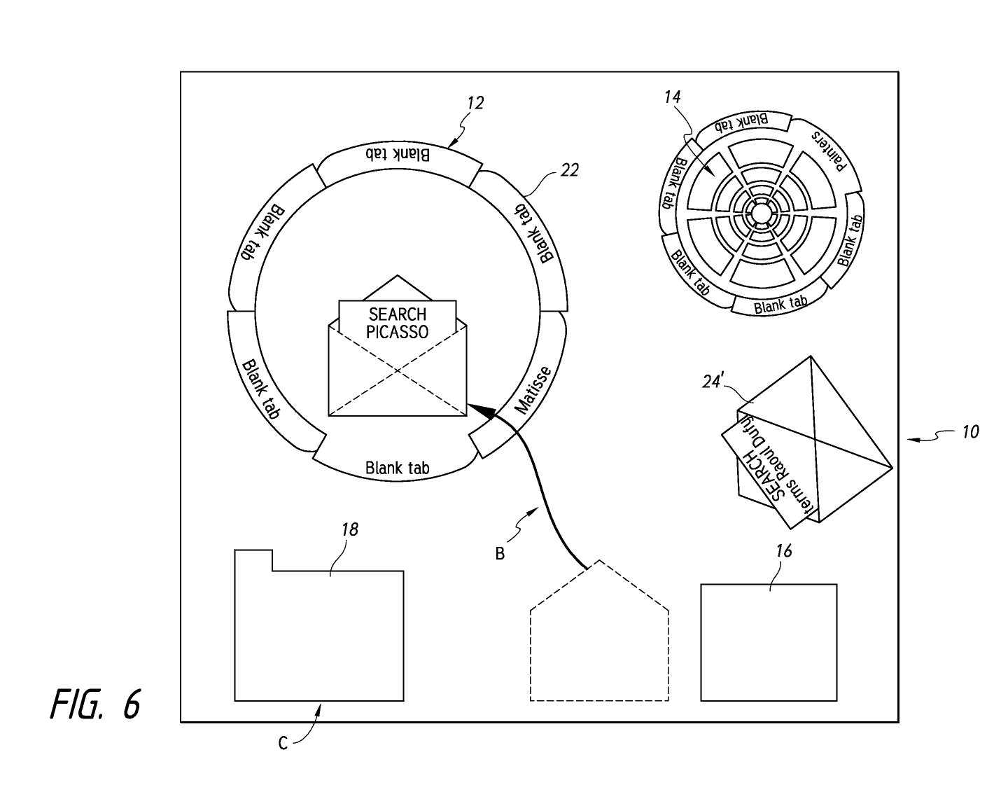

FIG. 6 illustrates the execution of a web search request using key words that are input into the input component of FIG. 4;

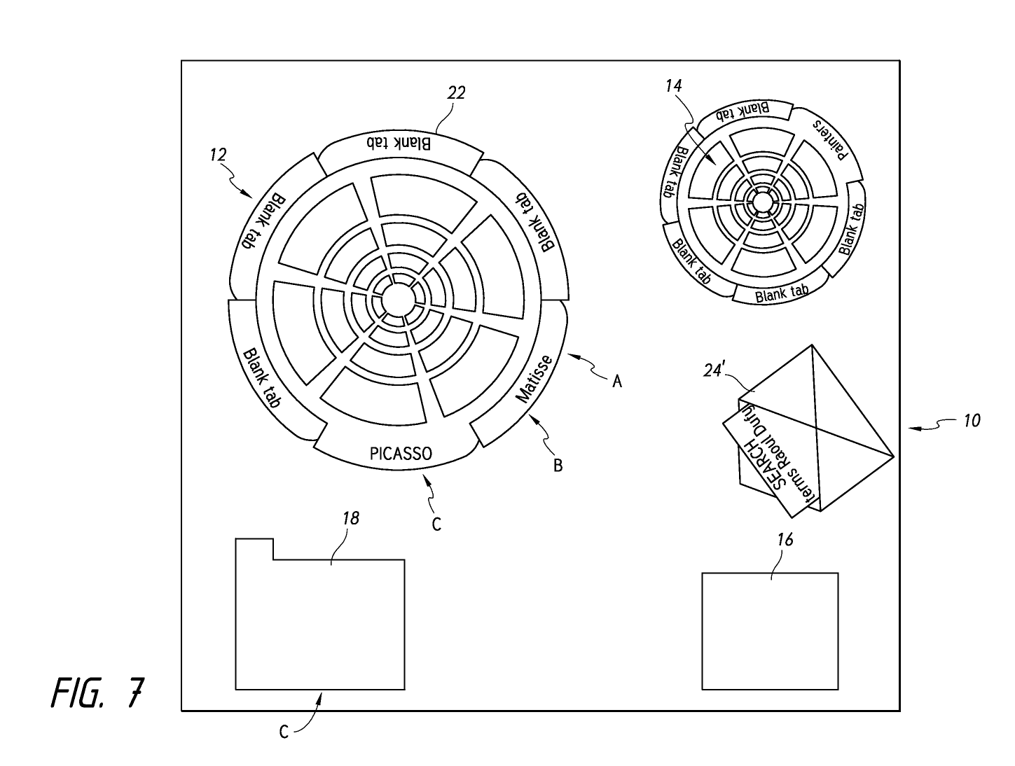

FIG. 7 represents the shared interface of FIG. 1 in which the shared web browser displays, in the form of tags, the results of the request of FIG. 6;

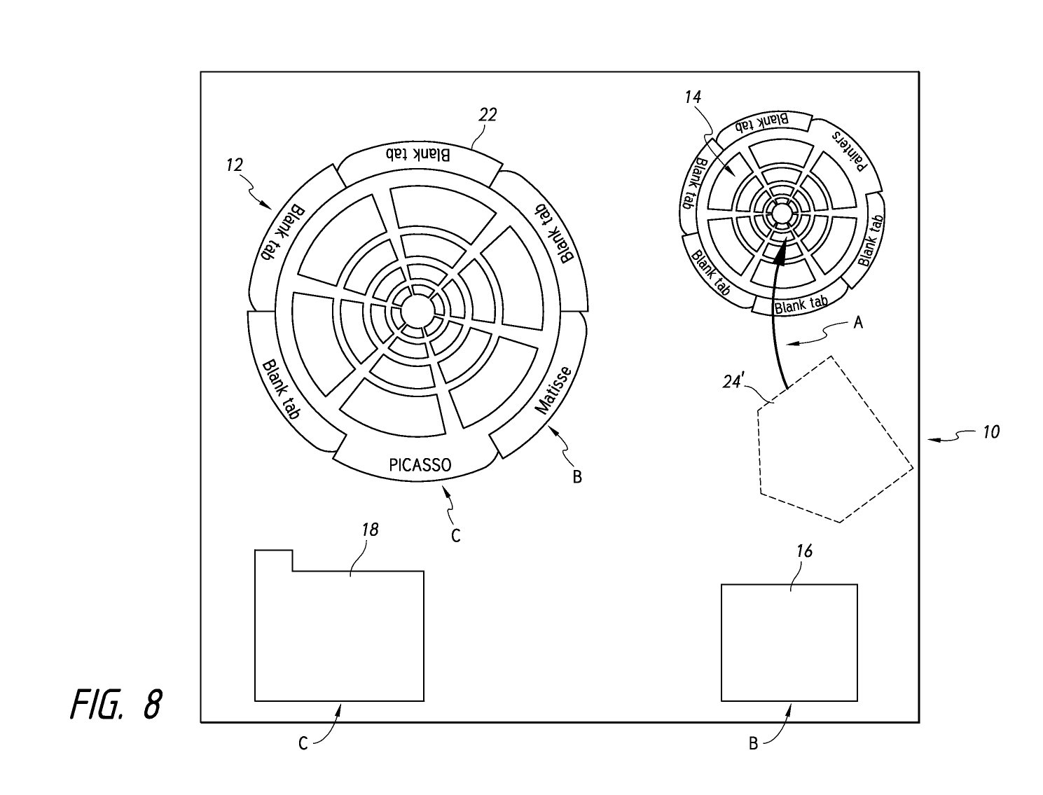

FIG. 8 illustrates the execution of a web search request of another user in a web browser for a personal purpose; and

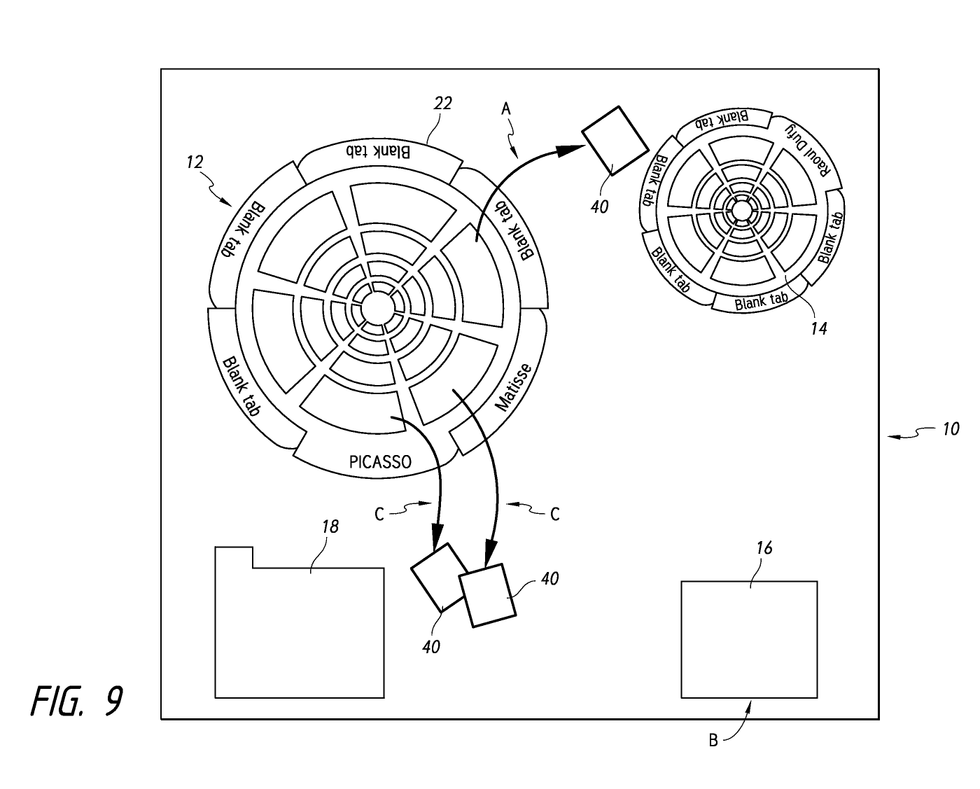

FIG. 9 illustrates the personal exploitation of the results of the web search requests by the users.

FIG. 1 shows the shared physical interface 10 of a piece of equipment, shared among multiple users A, B, C. This shared physical interface 10 makes possible the simultaneous interaction of multiple users in the computer environment displayed on this interface. In particular, this shared physical interface 10 can be of the following types: table, tablet or interactive screen, TabletPC touch screen, white board, interactive wall, or multi-touch digital board.

The interaction means (keyboard, mouse) can be integrated into the display interface (touch screen with presentation of virtual keyboards) or can be conventional peripherals connected to a central unit that controls the shared display interface.

FIG. 2 diagrammatically shows a system 50 for the implementation of the invention, in particular the equipment that has the shared physical interface.

The system 50 comprises a communication bus 51 to which are connected a central processing unit or “microprocessor” 52, a random access memory 53, a read-only memory 54, a display device 55, a pointing device 56, and optionally other peripherals 57 (communication interface, CD or disk player, etc.).

The read-only memory 54 comprises programs whose execution makes possible the implementation of the process according to the invention, as well as executable files of software applications used by the different users A, B, C.

During the execution of the programs, the executable code of the latter is loaded with random access memory 53, RAM type, and executed by the microprocessor 52. This execution makes possible the control of the shared physical interface 10, in particular the display of a digital work space, as shown in FIG. 1, of application windows, as well as the execution, strictly speaking, of the applications displayed in these windows.

The display device 55, such as a screen, an LCD pad or a video-projector, makes possible the display of the shared graphic interface 10 by which the users visualize the execution of applications through windows and interact on them.

The pointing device 56 can be integrated into the display device, in particular when it involves a touch screen, or offset, for example, a mouse, a touchpad, or else a graphic tablet.

The device described here and particularly the central unit 52 are able to implement all or part of the processing cycles described in connection with FIGS. 1 and 3 to 9, to implement the processes that are the objects of this invention, and to constitute the systems that are the objects of this invention.

Returning to FIG. 1, the digital work space (or “office”) displayed on the shared interface 10 comprises a web browser 12 that is shared among the three users (symbolized by the dotted arrows—below, the dotted arrows symbolize the action of a user on a shared interface component 10) and displayed through a common application window 22.

The concept of “common” results here from a convention that is fixed by the users, according to which this application window, and therefore the corresponding web application, are the object of their attention simultaneously for the purposes of collective works. Thus, a shared or common web browser is therefore technically similar to a web browser for a personal purpose, if it is only that it captures the attention of the group of users. Thus, a personal browser can become a common browser according to the interest that it bears subsequently, in connection in particular with collaborative works on the latter.

The web browser 12 that is shown here is circular, making it possible for multiple users to read around the interactive table, as shown in particular in the publication “Personal Digital Historian: Story Sharing Around the Table,” Shen, C.; Lesh, N.; Vernier, F., ACM Interactions, ISSN: 1072-5520, Vol. 10, Issue 2, pp. 15-22, March/April 2003.

In a way that is known in the art, a web browser makes it possible to access various services or functions either locally or by means of remote servers. The image search or web site functions, the functions for access to the file exchange servers (called FTP) or the file-sharing functions are just so many examples.

The work space also comprises zones that are attributed to each user based on his place around the interactive table, for the purposes of implementing personal actions. In our example, the user A uses a web browser 14 that he alone uses in the top corner to the right of the interface as shown in the figures; the user B uses an application 16 for personal use (bottom corner on the right); and the user C opened, for example, a file explorer 18 (bottom corner on the left).

Hereinafter, the example of a common effort among the three image search users on the Internet, using the shared web browser 12, is taken.

According to the invention, each user who wants to input a new search request creates a personal component for inputting search criteria or parameters. In this stage, this personal component is completely independent of the common application component 22 that displays the shared web browser 12 and any other application that offers the same search function (browser 14). The user then inputs his request in this new component, and then after having negotiated the authorization with the other users, he sends the input to the shared browser, focus of the attention of the group. If the partners are not in agreement, then the user can paste his request on his personal browser that he will have opened in advance.

The invention thus rests on a separation between the component for input of parameters for the request and that (web browser) for execution of the latter and display of the result.

This separation has the advantage of making it possible for each one to input a request independently for the purpose of contributing to the collective effort and therefore offers a greater freedom of interaction for each user.

This method also makes it possible to launch the request that is thus input in the browser of his choice: if the participants refuse that the user in question controls the shared browser, then the user is free to send his request to a new browser that he opens for this purpose; if, on the contrary, there is agreement, then the input request is directed to the shared browser.

Thus, multiple users can input, at the same time, different requests and then can negotiate between themselves simply the relevance of their request before submitting it by a drag-and-drop action into such and such a browser according to the consensus adopted by the users. The absence of control on the shared browser makes the negotiation of a new search less difficult.

Furthermore, this separation prevents impeding the activity of other users: the latter are not disordered during the input of the new request by one of them since it takes place on a personal component that is separate and independent from that of the shared web browser 12.

Thus, in connection with FIGS. 3 and 4, when one of the users, here the user B, thinks of a new search request, he creates the input component 24 of the request, separate and independent from the common application component 22 that displays the web browser 12.

In our example, the creation of this input component can be carried out by the trace (for example using a finger or a stylus on the touch screen) of a graphic shortcut, here a question mark 30 (FIG. 3), with which is combined the input component of the request 24. Thus, the control system of the shared interface 10 detects the trace of the question mark 30 and automatically displays the input component 24 (FIG. 4).

The input component 24 is individualized here for the user B in his personal work zone, because it has the purpose of being used by the latter for an individual action. Within the scope of the invention, this input component 24 is not affected a priori in that it is linked neither to a web browser nor to any application opened by the users. As seen above, such an input component 24 can then be linked to the shared browser 12 or to a “personal” browser 18 according to the end of the negotiations between the different users.

It will be noted that the conventional graphic components generally have relationships of predefined dependencies between them, such that it is not possible a posteriori to assign them to just any application during execution.

Thus, as illustrated in FIG. 4, the input component 24 can only be a graphic component with a field of input of key words, similar to a toolbar. This field can correspond in particular to a field of an XML document, a source that is used for the display of this component.

Alternative mechanisms for the use of a graphic shortcut 30 can be considered. For example, the user B can trace on the shared interface 10 a geometric shape, here a rectangle 32, defining the display shape of the input component 24. Furthermore, the assignment of this component to a particular function (for example, input function of a request, calculating function, file explorer function, etc.) can be carried out through a selection in a menu that displays one time the shape that is traced. In addition, this menu can be contextual in that the displayed inputs in the menu depend on the environment for execution (for example, the active window at the time of the trace, the windows that are open at the same time, etc.). Thus, various mechanisms for creation of the input component 24 can be provided.

Of course, these menus make it possible to specify to what type of function of an application this new component corresponds: for example, to the input of search criteria for a web browser, to the input of exploration parameters for a file explorer, etc.

In our example, the request input component 24 is depicted in the form of an envelope. It makes it possible to define one or multiple parameters relative to the search to be performed in a web browser. In particular, it makes it possible to select the type of documents sought (videos, images, web pages), and the site of the search (on local disks, in the local network, or on the Internet), and to input key search terms in a text input zone, for example a zone that can be activated with a finger, of which the text is input using a virtual keyboard 26 (displaying the activation of the input zone). This is illustrated in FIG. 5, showing the input of the word “PICASSO” in the input zone.

Furthermore, this same FIG. 5 shows another input component 24′ that the user A created (in a way that is similar to that which was described above). The user A also provides information on the input zone with, here, the terms “RAOUL DUFY” by means of the virtual keyboard 26′.

In this stage, the collaborative work involves a negotiation between the different users to know which of the requests established by the different users is to be shared (user C may also have prepared a request via another request input component that is independent from the common component 22).

After discussion, a consensus is established, for example, that the request of the user B is presented as in the shared web browser 12 for the purposes of carrying out a collective work above.

Thus, after agreement between the users around the table, the user B sends his request (in this stage, not assigned to a particular web browser) to the shared web browser 12. For this purpose, he moves his individualized input component 24 on the common component 22 that displays the shared web browser 12 (FIG. 6), and then it is released (drag-and-drop action that is well known to one skilled in the art), so as to trigger the execution of the search by the shared web browser 12.

This startup causes the extraction of the input text from the component 24 (here, an XML field in the XML file that codes the component), and optionally other parameters that relate to the search function (search location, type of documents searched). These data are therefore recovered by the management system for forming a conventional search request, for example http, indicating these different criteria and parameters and with the destination of a search engine. The format of such a request is not described in more detail because it is well known to one skilled in the art, in particular in the domain of the Internet.

It is noted here that it is the action of pasting the input component (independent) 24 on the browser 12 that links/combines the request parameters that are input to the shared browser.

Following the execution of this request (search for images, for example), the system recovers, from the Internet for example, a response that comprises a number of images. A display of these images is then carried out in the shared browser 12 (here in a circular way) at the level of a tab that reproduces the key search terms (FIG. 7).

Each user A, B or C can then interact with the shared browser 12 as provided in a common work and as shown by the three dotted arrows A, B, C on the common component 22.

In a way similar to the “common” exploitation of the request of the user B, the user A may wish to send, by drag-and-drop components, his own request into a web browser for personal purposes 14 (FIG. 8). This decision can result from the refusal of his request by all of the users or a desire to verify the relevance of his request before drawing the attention of the other users to the latter (for example, by dedicating this web browser from now on to common usage, for example by enlarging it and centering it in the center of the interactive table at the site of the shared web browser 12).

The search parameters and criteria about which the user A gives information are then extracted from the component 24′ that is pasted onto the browser 14 to generate a conventional http request intended for a search engine. The results of this request are then displayed in the display component of the browser 14 (image tags), as shown in FIG. 9.

Of course, because of the independent nature of the individualized components, the component that is created by the user A would have to be linked to the common browser 12 if a consensus with the other users had been found.

The invention as described in this example makes it possible to make the interaction between the users more fluid by separating, into two independent components, the request input zone (or parameters) of the display zone. Traditionally, these two zones are combined in a single application component, for example in the traditional web page of the search engines or in the browser that integrates, in the same component, a display zone of the web page and a toolbar zone for input of key words. In the known solutions where two components are still used, the latter are closely linked in such a way that they can only be used together.

This independence rests on the absence of the predefined link between the request input component and the common display component (before the user explains this link by drag and drop of the input component in the display component, for example). This absence of link makes it possible for multiple users to have their own input component for carrying out simultaneously, in the same work space, personal actions in connection with the work in common. A subsequent negotiation among these users makes it possible to determine which of the input requests is submitted in the shared browser. This scheme makes it possible to prepare the requests without ineffectively monopolizing the shared browser.

Owing to this absence of link, the requests that are not adopted can nevertheless be exploited individually by each of the corresponding users.

FIG. 9 also shows the exploitation of the common search work by each of the users. As seen above, the result of the search is displayed, in the shared browser 12, in the form of image tags that symbolically represent hyperlinks to the web pages. Depending on the case in question, these results can also be exhibited in the form of texts.

Following this collective search phase, the users wish to initiate an individual exploration phase by selecting certain links.

As illustrated in the figure, a user then places his finger on a tag (i.e., a hyperlink): this long holding of the key detaches the tag from the shared browser 12; then by dragging, the user extracts the tag beyond the shared browser 12 (solid arrows), where it persists, for creating an independent component 40 that reproduces the information of the hyperlink. Therefore, by simple dragging and dropping, an independent component is created outside of the shared browser 12 for each desired information object that is listed in the displayed page of the shared browser.

In particular, the hyperlink information can be extracted and copied from the html page of results displayed in the browser 12, using an html syntax analysis device (parser).

This component 40 is defined, for example, by an XML or HTML file, also comprising the extracted hyperlink, and it is displayed as a tag if the hyperlink is an image or is in text form if the hyperlink is a web page.

In our example, the user A recovers a single hyperlink that he copies in “his” work zone on the shared interface 10; the user C recovers two hyperlinks.

Several tags are thus extracted from the shared browser 12 so that each user can subsequently consult the selected results, for example by clicking on the thus created component 40 or by dragging it toward a browser for personal purposes 14.

It is seen here that this extraction of hyperlinks from the common application component 22 can be carried out quickly by the users by dragging and dropping, without causing a significant problem for the other users.

This makes it possible to reconcile, at any time, the collective interaction and the individual interaction: if the object of the attention of a user (a particular hyperlink) is not the object of attention of the group, he can then “take” it and consult it in “his” personal work zone, without disturbing the others.

Of course, if the personal attention and the collective attention coincide, then it is possible to open the hyperlink in the shared browser 12 for continuing the collaborative work.

The preceding examples are only embodiments of the invention that is not limited thereby.

In particular, although the description above relates to web browser-type applications, the invention applies to any type of software application that is provided with a function for which, according to the invention, parameters are then specified via an input component that is separate from the one for execution of the application. The collective work then consists in exploiting in common an input (of parameters) that is done in isolation by one of the users.

1. Process for interaction with an application that is shared among multiple users, the shared application having at least one function and being displayed in a common application component of a physical interface that is shared among the users, whereby the process comprises the stages that consist in:
Creating an individualized component, independent from said common application component, with which a user can interact individually;
Using the shared physical interface to define, by the user, at least one parameter of said function inside the individualized component that is created;
For said user, interacting with the shared application by linking said individualized component that comprises at least one defined parameter to the common application component so as to define said function.

2. Process according to claim 1, in which the action of interaction with the shared application comprises a drag-and-drop action of said individualized component on said common application component.

3. Process according to claim 2, in which—the shared application implementing a search function in at least one digital data source—the drag-and-drop action on the common application component triggers the execution of a request that comprises, as a search criterion, said at least one parameter.

4. Process according to claim 1, comprising the stages that consist in:
Creating, by at least one other user, an individualized component, independent from the common application component, with which this other user can interact individually;
Using the shared physical interface to define, by this other user, at least one parameter of said function inside of the individualized component that is created by this other user;
Selecting a user from among the set of users for interacting with the shared application by linking the individualized component of the user that is selected to the common application component.

5. Process according to claim 4, in which the individualized components are configured to be linked equally to the common component that corresponds to said shared application or to another component that corresponds to another application, and a non-selected user interacts with said other application by linking his individualized component to said other component that corresponds to this other application.

6. Process according to claim 1, in which the creation of the individualized component comprises the trace, by the user, on the shared physical interface, of a graphic form so as to create, at the location for the trace, an individualized component that comprises a field for definition of at least one parameter of the function.

7. System for interaction with an application that is shared among multiple users and that has at least one function, whereby the system comprises:
A physical interface that is shared among the users, adapted to display said shared application in a common application component;
Means for creating, using the shared physical interface, an individualized component that is independent of said common application component, with which a user can interact individually, whereby said created, individualized component comprises a field for defining there at least one parameter of said function;
Means for processing an interaction signal from said user with the shared application by linking said individualized component that comprises at least one parameter that is defined to the common application component so as to define said function.

8. System according to claim 7, comprising:
A second application that implements at least one function, and
A number of individualized components, each equipped with a field for defining there said at least one parameter,
Said individualized components being configured to be equally linked to a component that corresponds to one or the other of the two applications that implement at least one function.

9. Means for storing information that comprises instructions for a computer program that is suitable for implementing the management process according to claim 1, when this program is loaded and executed by the computer system.

10. Computer program product that can be read by a microprocessor, comprising instructions for the implementation of the management process according to claim 1, when this program is loaded and executed by the microprocessor.
